(19) United States
(12) Patent Application Publication
(10) Pub. No.: US 2022/0390905 A1
(43) Pub. Date: Dec. 8, 2022

(54) METHOD FOR MANAGING A DISPLAY INTERFACE

(71) Applicant: Tissot SA, Le Locle (CH)

(72) Inventors: Edoardo FRANZI, Cheseaux-Noreaz (CH); Jean-Marc KOLLER, Yverdon-les-Bains (CH)

(73) Assignee: Tissot SA, Le Locle (CH)

(21) Appl. No.: 17/773,795

(22) PCT Filed: Oct. 30, 2020
(86) PCT No.: PCT/EP2020/080565

§ 371 Date: May 2, 2022

(30) Foreign Application Priority Data
Nov. 8, 2019 (EP) 19208052.1

(51) Int. Cl. G04G 99/00

(52) U.S. Cl. CPC G04G 99/006; G09G 2354/00; G09G 2356/00

(57) ABSTRACT

The invention relates to a method for managing a display interface formed of a plurality of display screens (3) of smartwatches (1) worn on parts of the body of users, which parts are capable of moving or are moving, said watches (1) being located in proximity of one another, the method comprising the following steps:
estimating (10) at least one broadcasting property of each display screen (3) in said display interface which they form together, and
managing the display (15) of a visual message on said display interface comprising a substep (18) of generating portions of said visual message as a function of measurement data relating to at least one broadcasting property, each portion being intended to be displayed on the screen (3) of each smartwatch (1);
broadcasting (19) portions of said message on each screen (3) constituting this display interface.

### TECHNICAL FIELD

The invention relates to a method for managing a display interface formed of a plurality of screens of smartwatches worn by users located in a same place.

The invention also relates to a computer program implementing such a method.

### TECHNICAL BACKGROUND

During the course of visual and/or sound activities such as shows in the form of concerts or sporting events, it is common that electronic devices such as smartphones, cameras or video cameras are brandished by members of the public, in particular to immortalise moments of the shows.

However, such a use of these devices during these shows has the major disadvantage of systematically generating visual pollution which then disrupts their proper course.

Under these conditions, it is understood that there is a real need to find a solution which can overcome these disadvantages of the prior art.

### SUMMARY OF THE INVENTION

One of the aims of the present invention is therefore to provide a method which aims to take advantage of smartwatch screens in order to contribute to the visual show of such visual and/or sound activities.

The invention relates to a method for managing a display interface formed of a plurality of display screens of smartwatches worn on parts of the body of users, which parts are capable of moving or are moving, said watches being located in proximity of one another, the method comprising the following steps:
estimating at least one broadcasting property of each display screen in said display interface which they form together, and
managing the display of a visual message on the display interface comprising a substep of generating portions of said visual message as a function of measurement data relating to at least one broadcasting property, each portion being intended to be displayed on the screen of each smartwatch, and
broadcasting portions of said message on each screen constituting this display interface.

In other embodiments:
the estimation step comprises a substep of establishing, by each smartwatch, said measurement data relating to at least one broadcasting property comprising at least one location property of said watch relative to the other smartwatches, the screens of which form the display interface;
the estimation step comprises a substep of establishing, by each smartwatch, said measurement data relating to at least one broadcasting property comprising at least one orientation property of the screen of said smartwatch;
the establishment substep comprises a phase of evaluating the position of each watch relative to other smartwatches which are located in its immediate environment;
the establishment substep comprises a phase of estimating the orientation of the screen of each watch;
the estimation step comprises a substep of transmission by the smartwatches of said measurement data to a management server of the display interface;
the display management step comprises a substep of producing the visual message to be displayed on said display interface;
the display management step comprises a substep of designing a mapping relating to the position of all the smartwatches and in particular of the screens constituting them and forming the display interface;
the design substep comprises a phase of selecting screens which are most suitable for the broadcasting of the visual message produced, depending on their orientation and the distance which separates them from the other screens;
the screens of the smartwatches are each specifically dedicated and configured for the display of a portion of visual message transmitted by the management server;
the screens of the smartwatches each have the sole function of displaying a portion of the visual message transmitted by the management server;
the screens of the smartwatches each have the sole function and/or purpose of constituting said display interface;
said smartwatches are capable of moving or are moving with respect to one another;
the smartwatches each comprise a main screen dedicated to the display of information relating to time information.

The invention also relates to a computer program comprising program code instructions for executing such steps of the method when said program is executed by processing units of a smartwatch and a management server of the display interface.

### BRIEF DESCRIPTION OF THE FIGURES

The invention will be described below in more detail using the attached drawing, given by way of example and in no way limiting, in which:

FIG. 1 is a representation of a method for managing a display interface formed of a plurality of screens of smartwatches worn by users located in a same place, according to an embodiment of the present invention.

### DETAILED DESCRIPTION OF THE INVENTION

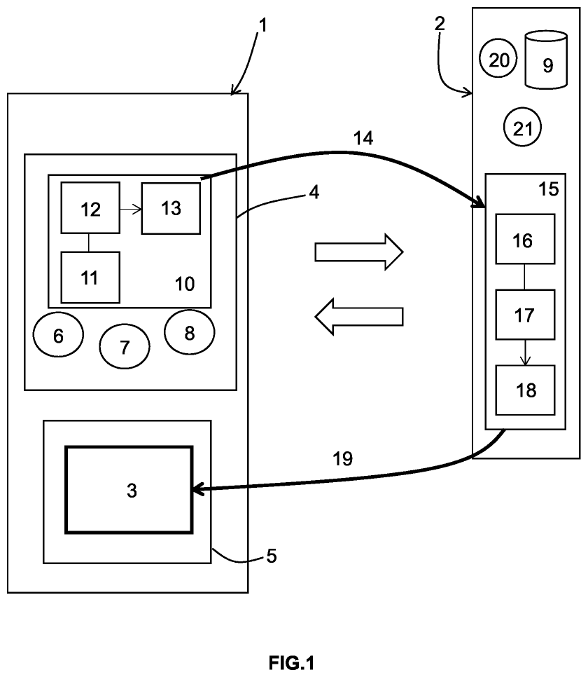

FIG. 1 illustrates a method for managing a display interface formed of a plurality of screens 3 of smartwatches 1 worn by users located in a same place. In this context, the watches are therefore located in proximity of one another in order to form this display interface. Such smartwatches are worn on parts of the body of users. These parts are capable of moving or are moving and may include, for example, the wrist, ankle, arm, foot, neck, leg or arm of each of the users. Such a display interface is therefore formed by the assembly of screens 3 of smartwatches 1 of users who are situated in a same location/situation/place. It is therefore understood that the users, each wearing a smartwatch 1, can be grouped in a concert hall or in an arena or even a stadium where a sporting event, for example, should take place.

In this method, the visual message is displayed by all of the screens 3 forming the display interface. Each screen 3 can be, for example, a secondary screen 3 of the smartwatch. This screen or, for example, this secondary screen 3, is not defined for displaying information specifically or exclusively intended for the user of said watch. Such information relates to the functions carried out by the watch 1, such as time information, alarm information, geolocation information, meteorological information, health information (blood pressure, heart rate, pulse oximetry, electrocardiogram), activity information, sport training or “sport coaching” information, etc., as can be here a main screen 4 of the watch 1. Indeed, such a screen 3 is arranged on the watch 1, for example in the strap 5 thereof, being configured to be controlled/administered by a management server 2 of the display interface included on a remote technical platform. This is a matrix type screen 3 and comprises light-emitting electrodes. Moreover, it is deformable and stretchable. Under these conditions, it is understood that each of these screens 3 is preferably specifically dedicated to and configured for producing such a display. In other words, the reference screens 3 of the smartwatches each have the sole function of displaying a portion of the visual message transmitted by the management server. In addition, these screens 3 each have the sole function and/or purpose of constituting said display interface.

This visual message is different from functions performed by the watch 1 due to the fact, in particular, that their broadcasting does not result from a prior configuration of a computer application of the watch by the user or even from an interaction between the input interface of this watch 1 and the user. Moreover, these visual messages are not intended exclusively for the wearer of the watch 1, as a function of the watch 1 such as an alarm can be. In the context of this embodiment, each visual message relates to a visual and/or sound activity (for example a sporting event, cultural event, show, concert, etc.) comprised/organised in an environment/location/place where said watch 1 is located. As already mentioned, this visual message is intended for a display interface formed by a plurality of screens of smartwatches 1 arranged in an environment/location/place close to the smartwatch 1. Moreover, this visual message aims, for example, to provide a visual contribution to the visual and/or sound activities. It is therefore understood that the content of this visual message is directly related to the visual and/or sound activity included in the environment where the smartwatch 1, and thus the user of the smartwatch 1, is located. Such a content can be synchronised to coordinated with this visual and/or sound activity. By way of example, such a visual message comprises an animated or static graphic representation. In a non-limiting and non-exhaustive manner, this message comprises an image comprising objects for a light pattern or even an emoticon-type figure symbolic of an emotion, an image exchange format (better known under the acronym GIF for “Graphics Interchange Format”, a word/term or a group of words/terms or even a video.

This method comprises a step 10 of estimating, by at least one processing unit 6 of each smartwatch 1, at least one broadcasting property of each display screen 3 in said display interface which they form together.

This step 10 comprises a substep 11 of establishing measurement data relating to at least one of the broadcasting properties, performed by each smartwatch 1. The broadcasting property comprises, in a non-limiting and non-exhaustive manner:
a location property of said watch 1 relative to the other smartwatches 1, the screens 3 of which form the display interface, for example the secondary screens of these watches, and/or
an orientation property of the screen 3 of said smartwatch 1, for example the orientation of the secondary screens of these watches.

Such features aim to identify/evaluate the broadcasting properties of each screen 3 in order to optimally configure the broadcasting properties of the display interface constituted by the screens 3. In other words, it is understood, for example, that a screen 3 can be activated/deactivated, in other words that it is capable of broadcasting or not broadcasting a portion of the visual message depending on its position and/or its orientation.

Such a substep 11 therefore provides an evaluation phase 12 implemented by the processing unit 6 connected to a position capture module 7 of each watch 1. During this phase 12, measurement operations are performed in order to evaluate the position of each watch 1 relative to the other smartwatches 1 situated in its immediate environment. This position capture module 7 of the smartwatch 1 is capable of detecting the other smartwatches 1 which are arranged in its immediate environment, in other words the other watches 1 which are close to it or in its proximity. Moreover, this module 7 of the smartwatch 1 is capable of determining the distance which separates it from the other watches 1 and of positioning each of the other watches 1 which are close to it with respect to/relative to its own position. To do this, such a module 1 can use:
a Bluetooth™ Low Energy technology, also known under the acronym “BLE” and in particular a functionality of this technology referred to as radiogoniometry, and/or
an ultra-wideband technology known under the acronym “UWB”.

The establishment substep 11 also comprises a phase 13 of estimating the orientation of the screen 3 of each watch 1. Such a phase 13 makes it possible, in particular, to identify the broadcasting direction of this screen 3 of each watch 1. Such a phase 13 is implemented by the processing unit 6 and a module for measuring the orientation 8 of the screen 3 connected to this unit 6. This measurement module 8 may comprise one or more inertial sensors of the accelerometer, gyroscope or miniature multi-axis gyrometer type, such as multi-axis sensors manufactured with MEMS technology, capable of detecting angular velocities and linear accelerations along several axes, combining accelerometers and/or gyroscopes.

Next, the method comprises a step 14 of transmission, by the smartwatches, of said measurement data to a management server 2 of the display interface. During this step 14, the processing unit 6, being connected to a communication interface of each smartwatch 1, sends these data to the management server 2 via a communication network, such measurement data comprising the location and orientation properties. These data received by the server 2 are then archived in memory elements 9 of this server 2.

The method then comprises a step of managing the display 15 of a visual message on said display interface comprising a substep 18 of generating portions of said visual message as a function of measurement data relating to at least one broadcasting property, each portion being intended to be displayed on the screen 3 of each smartwatch 1. In order to do this, such a step 15 comprises a substep 16 of producing a visual message to be displayed on said display interface.

Such a substep 16 comprises a phase of generating visual message data. These visual message data participate in the production of this message. Such visual message data comprise contextual data relating to information concerning:
a theme/subject of the visual and/or sound activity/event at the place where the visual message is likely to be broadcast, and/or
synchronisation or coordination criteria between this activity/event and the visual message to be broadcast.

In other words, such a visual message is preferably produced in relation with the theme of the activity/event where it will be broadcast by being, for example, synchronised or coordinated with this visual and/or sound activity. The visual message data also comprise visual message definition data which are designed by a processing unit 20 of the management server 2, for example from an input interface 21 of the server 2, connected to the processing unit 20 where it is then possible to enter a message or even to select a predefined message stored in the memory elements 9 of the server 2. Next, the display management step 15 comprises a substep 17 of designing a mapping relating to the arrangement of all the smartwatches 1, in particular the screens 3, for example the secondary screen 3, constituting them and forming the display interface. This substep 17, which is implemented by the processing unit 20 of the server 2, comprises a phase of selecting the screens 3, for example secondary screens 3, which are most suitable for the broadcast of the visual message produced, and this with regard to their orientation, the distance which separates them from other screens 3 and their arrangement relative to these other screens 3. Such a selection phase comprises a sub-phase processing measurement data and virtual message data. It is noted that the virtual message data participate in defining, in particular, the nature or type of visual message produced to be broadcast. In other words, such a selection is carried out based on the measurement data and also as a function of the nature or type of visual message produced to be broadcast. On this basis, the processing unit 20 then constructs a virtual representation of the display interface on which the visual message will be displayed. In addition, it is understood that since the visual message conveys a piece of information which must be read (for example, an image containing objects or a text) and perceived by an individual, the distance between the screens 3 and their orientation are parameters which are assessed more restrictively, in order to allow this reading, than for a visual message which aims to create light effects.

Under these conditions, following the performance of this substep 17, the generation substep 18 then provides that, during its course, the processing unit 20 of the server 2, identifies, from the mapping relative to the arrangement of the screens 3 constituting the display interface, the screens 3 which are capable of broadcasting said visual message. Next, this processing unit 20 carries out operations separating/dividing the visual message into as many portions as there are screens 3 to ensure the broadcasting of the visual message on the visual interface. These portions are then transmitted to the corresponding smartwatches 1 via the communication interfaces of the server 2 and the smartwatches 1.

It is noted that the portions can have a similar content, for example in the case where the visual message relates to in-phase and coordinated light effects.

The method then comprises a step 19 broadcasting portions of said visual message on each screen 3 of a smartwatch 1 constituting this display interface, in particular as a function of their arrangement on this interface.

It is understood that steps 10 to 19 of this method are repeated as many times as is necessary in order to ensure an optimum broadcasting of the visual message and this in order, in particular, to take into account the many movements which can be carried out by the users of these smartwatches 1 worn on a part of the body that is moving or capable of moving, of these users, such as the wrists.

The invention also relates to a computer program comprising program code instructions for executing steps 10 to 19 of the method when said program is executed by the processing units of a smartwatch 1 and a management server 2 of the display interface.

1-15. (canceled)

16. A method for managing a display interface formed of a plurality of display screens of smartwatches worn on parts of the body of users, which parts are capable of moving or are moving, said watches being capable of moving or moving with respect to one another and being located in proximity of one another, the method comprising the following steps:
estimating at least one broadcasting property of each display screen in said display interface which they form together;
managing the display of a visual message on the display interface comprising a substep of generating portions of said visual message as a function of measurement data relating to at least one broadcasting property comprising a location property of each watch relative to the other smartwatches, the screens 3 of which form the display interface and an orientation property of the screen of said smartwatch, each portion being intended to be displayed on the screen of each smartwatch; and
broadcasting portions of said message on each screen constituting this display interface;
and in that said display management step comprises a substep of designing a mapping relating to the position of all the smartwatches and in particular of the screens constituting and forming the display interface, said design substep comprising a phase of selecting screens which are most suitable for broadcasting the visual message produced, as a function of their orientation and of the distance which separates them from the other screens.

17. The method according to claim 16, wherein the estimation step comprises a substep of establishing, by each smartwatch said measurement data relating to at least one broadcasting property comprising:
at least one location property of said watch relative to the other smartwatches, the screens of which form the display interface, and/or
at least one orientation property of the screen of said smartwatch.

18. The method according to claim 16, wherein the establishment substep comprises a phase of evaluating the position of each watch relative to other smartwatches which are located in its immediate environment.

19. The method according to claim 16, wherein the estimation step includes an establishment substep comprising a phase of estimating the orientation of the screen of each watch.

20. The method according to claim 16, wherein the estimation step comprises a substep of transmission by the smartwatches of said measurement data to a management server of the display interface.

21. The method according to claim 16, wherein the display management step comprises a substep of producing the visual message to be displayed on said display interface.

22. The method according to claim 16, wherein the screens of the smartwatches are each specifically dedicated to and configured for the display of a portion of visual message transmitted by the management server.

23. The method according to claim 16, wherein the screens of the smartwatches each have the sole function of displaying a portion of the visual message transmitted by the management server.

24. The method according to claim 16, wherein the screens of the smartwatches each have the sole function and/or purpose of constituting said display interface.

25. The method according to claim 16, wherein the plurality of smartwatch display screens are secondary screens of these smartwatches, each of these screens being able to be arranged in the corresponding watch strap.

26. The method according to claim 16, wherein the smartwatches each comprise a main screen dedicated to the display of information specifically or exclusively intended for the user thereof.

27. A computer program comprising program code instructions for executing steps of a method according to claim 16, when said program is executed by processing units of a smartwatch and a management server of the display interface.
